(19) United States
(12) Patent Application Publication
(10) Pub. No.: US 2008/0309936 A1
(43) Pub. Date: Dec. 18, 2008

(54) Spectrometer with multiple gratings

(75) Inventor: Mikko Krapu, Vantaa (FI)

Correspondence Address: WOOD, PHILLIPS, KATZ, CLARK & MORTIMER, 500 W. MADISON STREET, SUITE 3800, CHICAGO, IL, 60661, US

(73) Assignee: Oxford Instruments Analytical Oy

(21) Appl. No.: 11/820,178

(22) Filed: Jun. 18, 2007

(51) Int. Cl. G01J 3/18

(52) U.S. Cl. 356/328

(57) ABSTRACT

A spectrometric measurement apparatus comprises a collimator (401), a first diffractive grating (403), a second diffractive grating (404), and a detector arrangement (407). Incident radiation (402) from the collimator (401) is diffracted to the detector arrangement (407) either directly or through mirrors so that the first (403) and second (404) diffractive gratings diffract different wavelength ranges.

### TECHNICAL FIELD

The invention concerns in general the technology of spectrometers used to detect the intensity distribution of radiation at optical wavelengths, especially at ultraviolet wavelengths. More specifically the invention concerns the technology of building the polychromator of the spectrometer, in which a beam of incoming radiation is spatially dispersed depending on wavelength.

### BACKGROUND OF THE INVENTION

Optical emission spectroscopy (known as OES) is a method for analysing the material composition of a sample. A number of atoms and/or molecules of the sample material are excited with a stimulating burst of energy, and optical emissions resulting from the spontaneous relaxation of the excited states are collected and measured. The intensity distribution of the optical emissions contains important information about the concentrations of various component substances in the sample. A widely used application of OES is the sorting of scrap metal or other metallic parts. A typical way of providing the necessary excitation is to allow an electric spark or arc burn between an electrode and the surface of the sample, so that particles become detached from the surface and assume the state of plasma.

FIG. 1 illustrates schematically a known hand-held OES measurement unit. The front end of a roughly pistol-shaped body 101 comprises an electrode 102, which in the operating position comes close to a sample 103. An electric spark or arc between the electrode 102 and the sample 103 generates optical emissions, some of which are reflected by a first mirror 104 to a slit 105. The narrow beam that comes through the slit 105 hits a diffractive grating 106, which disperses the incident beam so that radiation of different wavelengths propagates further at different angles. Further mirrors, of which the second mirror 107 is an example, can be used to direct the spectrally dispersed radiation to a detector 108, the spatial resolution of which is sufficient to give the intensity distribution of the measured radiation as a result. Instead of or in addition to mirrors, the incident radiation may be brought to the slit 105 through other optical components such as lenses, optical fibres and the like.

FIGS. 2 and 3 illustrate the known difference between using a conventional holographic grating and photomultiplier tubes (as in FIG. 2) and using a flat-field holographic grating and a photodiode array (as in FIG. 3). The conventional holographic grating 201 of FIG. 2 focuses a number of spectral lines to certain points located on the perimeter of the so-called Rowland circle 202. Conventional spectrometers used a number of photomultiplier tubes like those shown as 203, 204, 205 and 206 as detectors that were placed at those locations where spectral lines of interest would appear. A flat-field holographic grating 301 causes the fan-shaped dispersed spectrum to focus onto a more or less linear focal plane, at which an array of contiguous detectors like the photodiode array 302 can be placed. A prior art publication GB 2 212 909 A illustrates some measurement configurations that employ a flat-field holographic grating.

The obvious advantage of an arrangement based on a flat-field grating is its ability to measure an essentially continuous spectrum, instead of only measuring some individual spectral lines like in the arrangement of FIG. 2, where the physical dimensions of the photomultiplier tubes makes it impossible to place them very close to each other. The characteristics of the flat-field-based arrangement also allow making it smaller than the conventional arrangements, which is important concerning the spatial limitations inherent to portable measurement appliances. The measurement device that was schematically illustrated in FIG. 1 employs a flat-field holographic grating. It should be noted that the second mirror 107 only functions to fold the optical path so that it can be fit into a shorter physical space. Otherwise the polychromator arrangements of FIGS. 1 and 3 are equal.

The disadvantages of an arrangement based on a flat-field holographic grating are usually related to aberration. It has proven to be relatively difficult to construct the arrangement so that the focal plane would really be as flat as a regular photodiode or CCD (charge-coupled device) array. Aberration causes spectral lines to become unsharp at the detector and overlap with each other. Overlapping is especially disadvantageous if one would like to separately measure spectral lines that are relatively close to each other, like the 174 nm line of nitrogen, the 178 nm line of phosphorus and the 180 nm line of sulphur (note that these wavelength readings are approximate).

### SUMMARY OF THE INVENTION

An objective of the invention is to present a spectrometer, the polychromator and detector parts of which involve better sharpness and less overlapping of spectral lines than in prior art arrangement. An additional objective of the invention is to present a spectrometer solution that is accurate and reliable despite of its relatively small size. Yet another objective of the present invention is to offer means for detecting a relatively wide range of wavelengths in a small-sized spectrometer.

The objectives of the invention are achieved by using at least two diffractive gratings in parallel, so that one part of the incoming radiation hits a first grating and a second part of the incoming radiation hits a second grating.

A spectrometric measurement apparatus according to the invention comprises:
a collimator adapted to produce a beam of incident radiation,
a first diffractive grating at a location where said first diffractive grating is adapted to receive a first part of said incident radiation,
a second diffractive grating at a location where said second diffractive grating is adapted to receive a second part of said incident radiation, and
a detector arrangement at a location where said detector arrangement is adapted to receive radiation diffracted by said first and second diffractive gratings;
   wherein at least one grating parameter of the first diffractive grating is different than a corresponding grating parameter of said second diffractive grating.

The first and second diffractive gratings are most advantageously flat-field holographic gratings. They have one or more differently selected grating parameters, which means that they are optimised for slightly different ranges of input wavelengths. Mechanically the two gratings may be two different pieces, or they may be different parts of the same mechanical piece.

The dispersed radiation or spectrum created by the first grating is directed to a first detector and the spectrum created by the second grating is directed to a second detector. These may be parts of a single physical detector, so that one part of it is illuminated by the radiation dispersed by the first grating and another part of it is illuminated by the radiation dispersed by the second grating. Another alternative is that the two detectors are separate entities, but in any case it is considered advantageous if they are located approximately at the same focal plane. Mirrors or other radiation-directing means may be used to direct the dispersed radiation from the gratings to the respective detectors. If mirrors are used, they may be physically just parts of one and the same mirror, or they may be different mirrors for example located in slightly different ways.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF DRAWINGS

FIG. 1 illustrates a known hand-held unit for performing OES measurements,

FIG. 2 illustrates the principle of using a conventional grating and individual detectors,

FIG. 3 illustrates the principle of using a flat-field holographic grating and a continuous detector,

FIG. 4 illustrates the use of two gratings according to an embodiment of the invention,

FIG. 5 illustrates the use of two gratings according to another embodiment of the invention,

FIG. 6 illustrates an alternative way of placing two gratings,

FIG. 7 illustrates the use of multiple gratings, and

FIG. 8 illustrates a spectrometric measurement apparatus according to an embodiment of the invention.

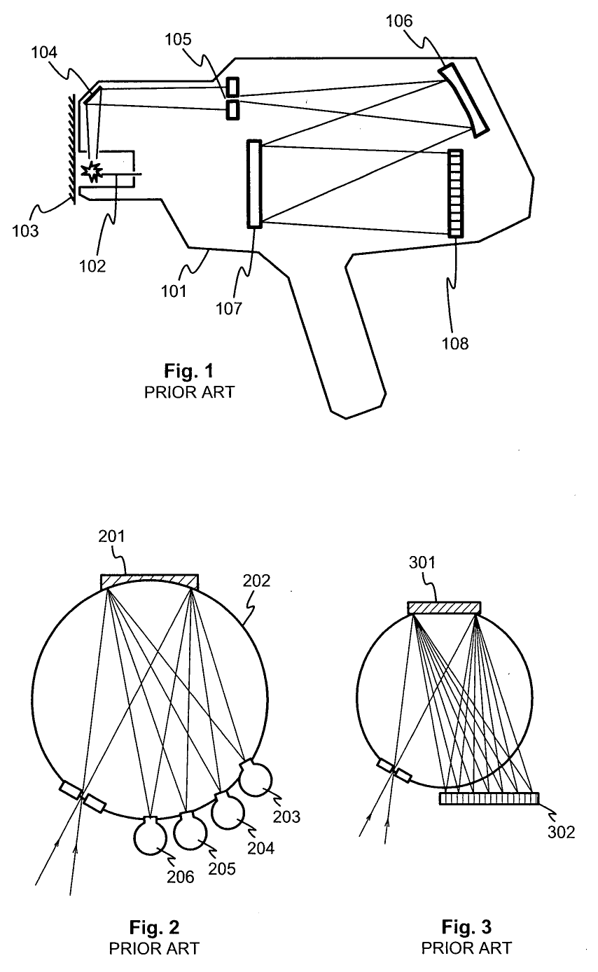

### DETAILED DESCRIPTION OF THE INVENTION

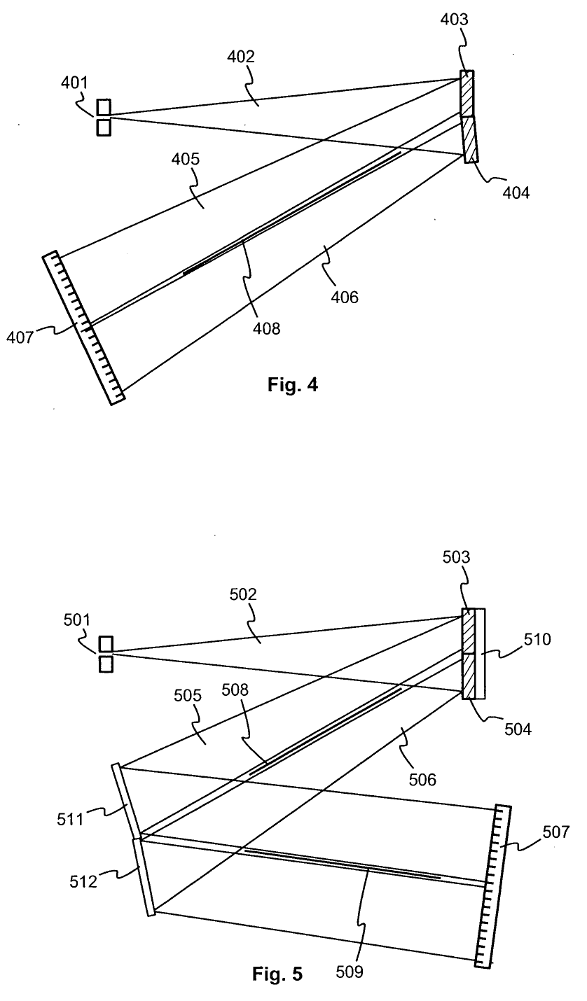

FIG. 4 is a schematic illustration of a spectrometric measurement apparatus for measuring intensity distributions of optical radiation according to an embodiment of the invention. Typical wavelengths to be measured with an apparatus of the kind illustrated in FIG. 4 are in the ranges of ultraviolet and/or visible light. A beam of incident radiation comes through some kind of a collimator, which here is the input slit 401. The beam of incident radiation is not as tightly collimated as a laser, but propagates into a continuous narrow range of angles and thus constitutes a narrow fan of incident radiation 402.

A first diffractive grating 403 and a second diffractive grating 404 are placed at locations where the first diffractive grating 403 receives a first part of the incident radiation and the second diffractive grating 404 receives a second part of the incident radiation. Diffraction occurs at both gratings, resulting in diffracted radiation. We assume that a first-order diffraction from the first grating is a first spectrally dispersed beam 405, and correspondingly a first-order diffraction from the second grating is a second spectrally dispersed beam 406. A detector arrangement 407 is placed so that it receives the first and second spectrally dispersed beams. The distance between the gratings and the detector arrangement 407 essentially equals the focal length of the gratings, so that spectral lines are sharp at the detector arrangement 407. An optional separator wall 408 may be used to keep diffuse radiation from propagating from the first grating to that part of the detector arrangement that should be illuminated by only first-order diffracted radiation from the second grating, and vice versa.

The use of a flat-field holographic grating and a linear continuous detector is always a certain compromise. The focal length of the grating is not exactly constant for the whole range of incident radiation but varies as a function of wavelength. As a result, the mathematically optimal form of the detector is typically not a straight line, but for example a kind of a gently undulating, slightly S-shaped curve. In practice one uses a linear (or planar) detector and tries to find the best possible location, where the mean or median value of aberration is the lowest. The wider the range of wavelengths to be covered, the larger the mean value of aberration is likely to be. An intuitive measure of aberration is the extent to which spectral lines are widened from their optimal, mathematically sharp form.

In the arrangement of FIG. 4 each individual grating only needs to cover a relatively narrow range of wavelengths. As a result, the mean value of aberration observed along the line determined by the detector arrangement 407 is much smaller than if one tried to direct first-order diffractions of the same overall range of incident wavelengths onto a linear detector with only one grating. Conceptually we may say that each partial length of the linear detector is individually available for better approximation of the curved optimal shape of the focal plane than the whole length of the linear detector, which one had to use in prior art solutions. Experience has shown that with two differently optimised diffractive gratings it is possible to reduce spectral line widening into less than one half from what would inevitably occur with only a single grating.

The graphical illustration given in FIG. 4, where each diffractive grating illuminates about one half of the detector arrangement, should not be construed as limiting. Typically there is some particular range of input wavelengths that is the most important, and therefore benefits the most from a specifically optimised diffractive grating. As an example we may consider the task of measuring the 174 nm line of nitrogen, the 178 nm line of phosphorus, and the approximately 180 nm line of sulphur. The overall wavelength range to be covered in the measurement could be from 170 nm to 400 nm. The half-and-half approach of FIG. 4 could suggest using the first diffractive grating for the range 170-280 nm and the second diffractive grating for the range 280-400 nm, but in order to give more emphasis to the lower end one could also optimise the first diffractive grating to a much narrower wavelength range, like 170-210 nm, and use the second diffractive grating to cover the rest of the input wavelength range.

The detector arrangement of FIG. 4 comprises a single linear (or planar) array of detector elements, which are typically photodiodes or the pixels of a CCD array produced on a common substrate. Individual detector elements are not separately shown in the drawing. The slightly different focussing properties of the two diffractive gratings have been accounted for by making each grating constitute a separate mechanical entity, so that the location and direction of each grating can be selected separately. It would be possible to put the gratings in exactly the same line and to use two slightly differently located linear detector elements in the detector arrangement, or to have both the two gratings and the two slightly differently located linear detector elements all individually located.

FIG. 5 is a schematic illustration of a spectrometric measurement apparatus for measuring intensity distributions of optical radiation according to another embodiment of the invention. The most prominent difference to the configuration of elements explained above is the use of mirrors to fold the optical paths of diffracted radiation. A first mirror 511 reflects the diffracted radiation from the first diffractive grating 503 towards a first part of the detector arrangement 507, and a second mirror 512 reflects the diffracted radiation from the second diffractive grating 504 towards a second part of the detector arrangement 507. The separator walls 508 and 509 are optional; they may help keeping unwanted diffuse radiation from causing interference.

In the embodiment of FIG. 5 the use of two separate mirrors means that one may find the optimal location for both of them separately. This in turn may enable placing both gratings 503 and 504 in a straight line directly next to each other, or even manufacturing the gratings on the surface of a common, planar substrate 510. Thus the grating arrangement can be a unitary mechanical entity, and also the detector arrangement can be a unitary mechanical entity. It is not impossible that in such a case even a mirror arrangement, which in FIG. 5 is illustrated as consisting of two mirrors, could consist of only a single mirror. However, because two separate diffracted beams are considered, it is typically helpful in finding the most optimal design if at least some of the optical elements (gratings, mirrors, detectors) can be individually placed for each diffracted beam.

Theoretically one could produce a combination embodiment from FIGS. 4 and 5, in which one of the diffracted beams would go directly from a grating to a respective detector, while the other diffracted beam would go through a mirror to a different detector located in a different place. However, such an arrangement would necessarily mean using two different detectors and also reserving more space, so it is difficult to see what particular advantage it would involve.

Known flat-field holographic gratings often consist of arrays of parallel grooves on a polymer surface. Gratings etched on silicon or other non-polymeric surfaces are also known. Grating parameters, which can be selected to optimise a grating for a desired range of wavelengths, include but are not limited to groove spacing, groove depth, groove width, groove profile, and the directional angles of the grating. The technology of optimising the location and use of a given pair of a grating and a detector for a given wavelength range is known as such from prior art spectrometers that only had a single grating.

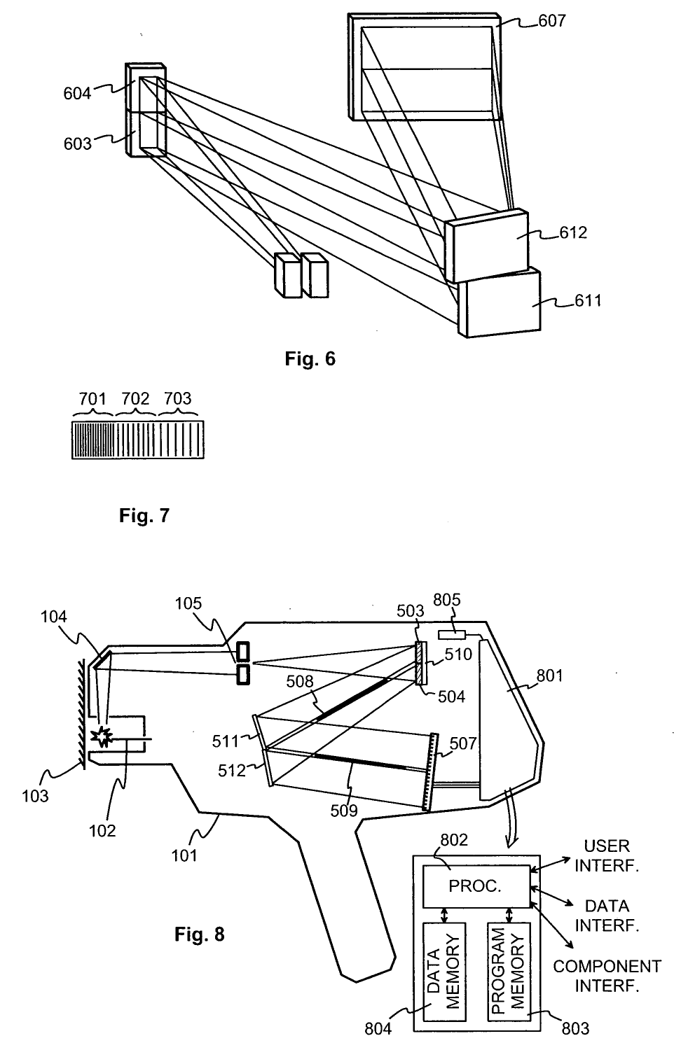

Above we have assumed that the first and second diffractive gratings are mutually located side by side in the optical plane, i.e. so that the displacement between the gratings is in the plane determined by the central lines of the radiation beams propagating between the entrance slit, the gratings, the mirrors and the detectors. This is not the only possible configuration. FIG. 6 illustrates an alternative solution, in which the two gratings 603 and 604 are side by side, but mutually displaced in a direction that is at a right angle against the “optical plane”, although in this case that concept already becomes a bit blurred because the propagation of radiation must be considered in three dimensions. Also the mirrors 611 and 612 are mutually displaced at least in the same direction as the mutual displacement of the gratings, and as a detector arrangement 607 there is a two-dimensional CCD array.

The number of individual gratings may be larger than two. FIG. 7 illustrates schematically a grating arrangement, in which a first grating 701, a second grating 702 and a third grating 703 have been manufactured onto the surface of a common substrate. In some cases an interlaced arrangement of two gratings could be considered, for example so that in the integrated multigrating of FIG. 7 the gratings 701 and 703 could be parts of the same grating (i.e. have similarly selected grating parameters) and grating 702 between them would be a clearly different grating with differently selected parameters.

FIG. 8 illustrates schematically applying the invention in a spectrometric measurement apparatus that externally resembles one known from prior art. The body 101, the electrode 102, the front end of the apparatus that comes next to a sample 103, the directing and focusing optics (represented here by the first mirror 104), and the collimator (slit 105) can be even exactly the same as in a prior art apparatus, like one commercially available under the registered trademark ARC-MET from Oxford Instruments Analytical Oy, Finland. In this exemplary device the polychromator arrangement resembles that illustrated above in FIG. 5, with the two gratings 503 and 504 on the common substrate 510; the separator walls 508 and 509; the two mirrors 511 and 512; and the detector arrangement 507.

A programmable electronics part 801 of the apparatus comprise a processor 802, which is adapted to execute computer-readable instructions stored in a program memory 803 and to store acquired measurement data in a data memory 804. A user interface, a data interface and a component interface to the processor 802 enable implementing interactions with a human user, exchanging digital information with other devices, and arranging the connections between the programmable electronics part and the other parts of the measurement apparatus, in a way known as such from corresponding prior art devices.

In order to take into account the enhanced measurement capability due to the double grating approach, the control program or computer-readable instructions stored in the program memory 803 must be designed so that it enables correctly converting readings from the detector arrangement 507 into intensity information as a function of wavelength. Calculations, experiments and calibration will show, which wavelengths of diffracted radiation will fall onto which detector elements of the detector arrangement 507. If a separator wall or some other structural feature causes a blind spot to be created at some part of a continuous detector array, it can be compensated for in software by programming the apparatus to ignore the blind spot. Temperature changes will cause corresponding changes in the physical dimensions of the device. These can also be compensated for in software, so that either the processor 802 obtains temperature readings from a temperature sensor 805 and makes corresponding default corrections to all obtained readings, or the processor 802 recognizes some easily detected characteristic features of a measured spectrum, compares their detected locations in the array of detector elements to expected locations that were based on calibration, and deduces, how much creeping has occurred due to temperature or other factors, and makes the appropriate corrections.

The exemplary embodiments described above should not be construed to pose limitations to the more general applicability of the appended claims.

1. A spectrometric measurement apparatus for measuring intensity distributions of optical radiation, the measurement apparatus comprising:
a collimator adapted to produce a beam of incident radiation,
a first diffractive grating at a location where said first diffractive grating is adapted to receive a first part of said incident radiation,
a second diffractive grating at a location where said second diffractive grating is adapted to receive a second part of said incident radiation at the same time when said first diffractive grating receives said first part of said incident radiation, and
a detector arrangement at a location where said detector arrangement is adapted to receive radiation diffracted by said first and second diffractive gratings;
wherein at least one grating parameter of the first diffractive grating is different than a corresponding grating parameter of said second diffractive grating.

2. A spectrometric measurement apparatus according to claim 1, wherein said first and second diffractive gratings are mechanically separate pieces, the location and direction of which are set individually.

3. A spectrometric measurement apparatus according to claim 1, wherein said first and second diffractive gratings are parts of a single mechanical piece.

4. A spectrometric measurement apparatus according to claim 3, wherein said first and second diffractive gratings are two adjacent, differently patterned areas on a surface of a common substrate.

5. A spectrometric measurement apparatus according to claim 1, wherein said first and second diffractive gratings are flat-field holographic gratings.

6. A spectrometric measurement apparatus according to claim 1, wherein said detector arrangement comprises a continuous and linear array of adjacent detector elements.

7. A spectrometric measurement apparatus according to claim 6, wherein said array of adjacent detector elements is a photodiode array.

8. A spectrometric measurement apparatus according to claim 6, wherein said array of adjacent detector elements is a CCD detector.

9. A spectrometric measurement apparatus according to claim 1, comprising:
a first mirror at a location where said first mirror is adapted to reflect diffracted radiation coming from said first diffractive grating towards said detector arrangement, and
a second mirror at a location where said second mirror is adapted to reflect diffracted radiation coming from said second diffractive grating towards said detector arrangement.

10. A spectrometric measurement apparatus according to claim 9, wherein said first and second mirrors are mechanically separate pieces, the location and direction of which are set individually.

11. A spectrometric measurement apparatus according to claim 1, wherein:
said first diffractive grating is adapted to diffract parts of the incident radiation having at least wavelengths of 174 nanometres, 178 nanometres, and 180 nanometres towards the detector arrangement either directly or reflected through a mirror, and
said second diffractive grating is adapted to diffract parts of the incident radiation having wavelengths that are longer than those diffracted by the first diffractive grating towards the detector arrangement either directly or reflected through a mirror.

12. A spectrometric measurement apparatus according to claim 1, wherein the spectrometric measurement apparatus is contained in a hand-held measurement unit adapted to produce electric discharges at a surface of a sample, so that optical radiation from a produced discharge is adapted to be directed to said collimator for producing said beam of incident radiation.
